(19) United States
(12) Patent Application Publication
(10) Pub. No.: US 2012/0014633 A1
(43) Pub. Date: Jan. 19, 2012

(54) Antifriction Bearing Cage

(76) Inventors: Berthold Beyfuss, Kaisten (DE); Hans-Jürgen Friedrich, Konigsberg (DE); Fred Fuchs, Schweinfurt (DE); Alfred Radina, Massbach (DE); Jonas Schierling, Hassfurt (DE)

(21) Appl. No.: 13/126,407

(22) PCT Filed: Oct. 21, 2009
(86) PCT No.: PCT/EP2009/007540

§ 371 Date: Sep. 28, 2011

(30) Foreign Application Priority Data
Oct. 27, 2008 (DE) 20 2008 014 280.6

(51) Int. Cl. F16C 33/66; F16C 19/24; F16C 33/46

(52) U.S. Cl. 384/470; 384/577

(57) ABSTRACT

A roller bearing cage comprises first and second annular elements, each having at least three radially-extending bulges or indentations spaced around a circumferential direction of the annular elements. An axially-facing surface of each bulge or indentation serves as a guide surface for one axial end of a roller body. A plurality of bridge elements are bonded to and connect the first and second annular elements. Each bridge element is disposed between two adjacent bulges or indentations on a radial side of the annular elements that is opposite of the extension direction of the radially-extending bulges or indentations. The bridge elements are configured to support rolling surfaces of respective roller bodies such that a pocket for a roller body is defined between each two adjacent bridge elements and each two axially-opposing, radially-extending bulges or indentations.

The invention concerns a roller bearing cage having at least U-shaped-defined pockets for roller bodies.

A roller bearing cage is known, e.g., from DE 79 35 982 U1, which is comprised of two side parts and a plurality of bridge parts that are separately manufactured and connected with the side parts by welding or the like, wherein the bridge parts form pockets between them for accommodating the roller bodies. The side parts and bridge parts are manufactured from flat or profile-milled wire and the bridge parts are stamped to form the slip surfaces for the roller bodies.

It is an object of the present invention to provide an improved roller bearing cage having at least U-shaped-defined pockets for roller bodies.

The object is achieved by the subject matter of claim 1. Advantageous embodiments are described in the dependent claims.

According to claim 1, a roller bearing cage having at least U-shaped-defined pockets for roller bodies includes the following features:

At least one annular circumferential element, which is formed with at least three radial indentations or bulges distributed in the circumferential direction, whose inner or outer surfaces serve as guide surfaces for the cage, and

bridge elements are attached to the circumferential element in a material-bonded manner, wherein each one of the pockets extends between two adjacent bridge elements.

The invention is based upon the recognition, inter alia, that it is effective, in particular when the cage provides a shoulder guidance, to bridge a radial distance between the abutment of a surface of the circumferential element on an inner- or outer shoulder and/or an inner ring- or outer ring collar on the one side and a roller body abutment surface on the bridge elements on the other side. Due to the indentations or bulges according to the invention, the bridging is advantageously achieved with a very low material usage, as compared to an unbulged, circular-annular-like circumferential element. In particular, by welding the bridge elements onto the circumferential element, the similarly-formed bridge elements can be produced in a simple and cost-effective manner by cutting an appropriately-profiled bar or strip material, preferably made of steel, into sections. Relative to roller bearing cages that are machined from a hollow cylinder-like pipe, the roller bearing cage according to the present invention naturally also offers the advantage that no material waste results from a machining, in particular, of the cage pockets, and thus a material savings advantageously results as compared to such a machining method.

In an advantageous embodiment, the circumferential element on the one hand and the bridge elements on the other hand are formed with different properties. In this case, it is advantageously possible to pair different materials and, depending on the application, e.g., to produce less heavily-loaded elements from cheaper materials. Further, it is also possible to form one of the elements from a heat-treated steel for high wear resistance and to leave other elements untreated, e.g., for a high ductility.

In a further advantageous embodiment, it is possible to form at least one of the elements in a coated manner. In this case, due to the roller bearing cage being formed from the circumferential and bridge elements, it is much simpler and thus also more cost-effective to perform the coating of individual elements, e.g., the bridge elements. The same applies to a further advantageous embodiment, in which, e.g., ship-hull-like and/or droplet-shaped impressions are provided on the surfaces of the bridge elements that face the roller bodies and the impressions function as lubricant pockets.

Further advantages, features and details of the invention are derivable from the exemplary embodiments of the invention described in the following with the assistance of the Figures.

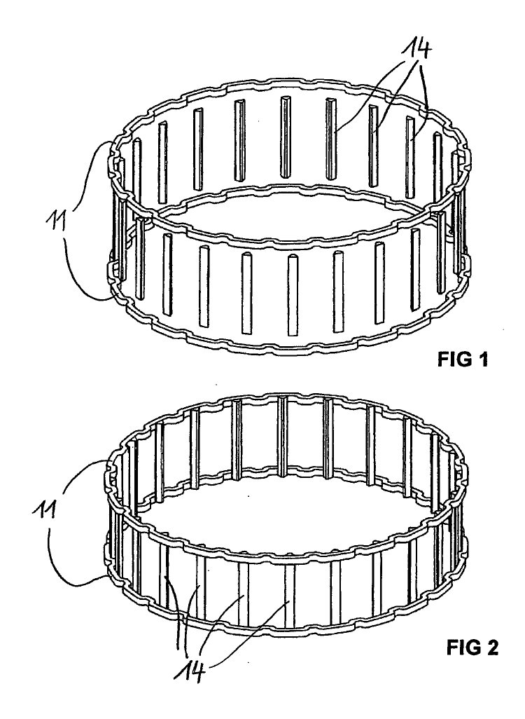

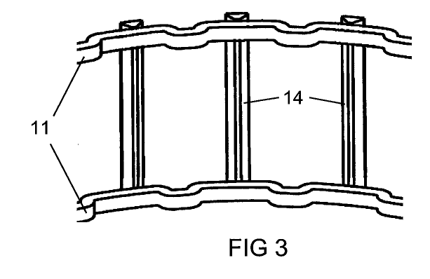

FIGS. 1 and 2 show in perspective view a cylindrical roller bearing cage having two undulated circumferential elements and bridge elements in an unconnected and a connected state of the elements.

As an exemplary embodiment of the invention, FIGS. 1 and 2 show in perspective view a cylindrical roller bearing cage having two circumferential elements 11, which are formed in an undulated manner in the circumferential direction, for bridge elements 14 having a uniform trapezoid-shaped cross-section. FIG. 1 shows the cage in a still-unconnected state of the elements 11 and 14 and FIG. 2 shows the cage after connection of the elements 11 and 14. The two circumferential elements 11 are formed with an undulation such that, in the area of the radially-inwardly-oriented indentations of the undulation, their inner surfaces serve as guide surfaces for guidance on an outer surface of a rim of an inner track element of a cylindrical roller bearing. The bridge elements 14 are welded to the inner surfaces of the circumferential elements 11, each between two adjacent indentations.

In another embodiment, the bridge elements 14 naturally could also be welded in the middle portion of bulges, which are bulged farther radially outward, or also on the outer surface side, whereby a still larger radial distance can be bridged between the guide surface and the side surfaces of the bridge elements 14 provided for contacting the rolling surfaces. The connecting portions on the circumferential elements for the bridge elements 14 can be formed in a manner fitted to the bridge elements 14 in accordance with DE 10 2007 202 113 A1. The attachment of the bridge elements 14 to the inner surface of the circumferential elements offers the completely obvious advantage that these bridge elements are inherently secured, in a manner of speaking, by the circumferential elements against the centrifugal force arising during operation of the cylindrical roller bearing due to the rotating cage. For an outer rim guidance, the preceding description applies inversely in a corresponding manner with radially-outwardly-bulging bulges of an undulated circumferential element.

The elements 11 and 14 are produced from an iron material, in particular from a steel wire. In other embodiments, however, other materials could be utilized and, instead of welding, soldering or adhesive could be applied. Furthermore, the bridge elements 14, in particular, can also be formed with a coating in order to achieve a particular sliding behavior, in particular in the area of its contact surfaces with the roller bodies.

Finally, the preceding description for a one-row cylindrical roller radial bearing as an example of a window-type cage is also applicable to other roller bearings, in particular tapered roller bearings, as well as also to spherical bearings, CARB-bearings and also barrel-shaped bearings, but also to bearings having comb-like cages, to roller bearings having multiple roller rows and also to axial bearings.

1.-19. (canceled)

20. A roller bearing cage, comprising:
at least one annular circumferential element having one of at least three radial indentations distributed in a circumferential direction thereof and at least three radial bulges distributed in the circumferential direction thereof, one of an inner surface and an outer surface of the indentations or bulges being configured serve as a roller body guide surface, and
a plurality of bridge elements bonded to the at least one annular circumferential element, each bridge element being disposed between two adjacent indentations or bulges on a side of the at least one annular circumferential element in a radial direction that is opposite of an extension of the indentations or bulges in the radial direction,
wherein an at least U-shaped pocket is defined between each two adjacent bridge elements, each pocket being configured to guide a roller body.

21. A roller bearing cage according to claim 20, wherein the at least one annular circumferential element and the bridge elements each comprise an iron material and the bridge elements are welded to the at least one annular circumferential element.

22. A roller bearing cage according to claim 20, wherein the bridge elements are bonded to the at least one annular circumferential element by one of soldering and adhesive.

23. A roller bearing cage according to claim 20, wherein the at least one annular circumferential element has a number of indentations or bulges equal to the number of bridge elements.

24. A roller bearing cage according to claim 23, wherein the roller bearing cage is configured to support a number of roller bodies equal to the number of bridge elements.

25. A roller bearing cage according to claim 20, wherein the bridge elements are attached to an outer surface of the at least one circumferential element in the radial direction.

26. A roller bearing cage according to claim 20, wherein the bridge elements are attached to an inner surface of the at least one circumferential element in the radial direction.

27. A roller bearing cage according to claim 20, wherein the at least one circumferential element has a uniformly undulating shape in the circumferential direction.

28. A roller bearing cage according to claim 20, wherein the at least one circumferential element has different material properties than the bridge elements.

29. A roller bearing cage according to claim 20, wherein at least one of the elements is at least partially coated with another material.

30. A roller bearing cage according to claim 20, wherein at least one surface of the bridge elements configured to contact the roller bodies includes ship-hull-shaped lubricant pockets.

31. A roller bearing cage according to claim 20, wherein at least a portion of the bridge elements has a substantially trapezoid-shaped cross-section with at least one side curved to conform to a rolling surface of the roller body.

32. A roller bearing cage according to claim 20, wherein the roller bearing cage is configured to support one of cylindrical roller bearings, tapered roller bearings and spherical roller bearings.

33. A roller bearing cage according to claim 20, wherein the bridge elements are cut to length from a profiled bar or strip material.

34. A roller bearing cage according to claim 20, wherein all the bridge elements have a uniform shape.

35. A roller bearing cage according to claim 34, wherein:
the at least one annular circumferential element has a number of indentations or bulges equal to the number of bridge elements and to the number of roller bodies,
the at least one circumferential element has a uniformly undulating shape in the circumferential direction,
at least a portion of the bridge elements has a substantially trapezoid-shaped cross-section with at least one side curved to conform to a rolling surface of the respective roller bodies, and
the roller bearing cage is configured to support one of cylindrical roller bearings, tapered roller bearings and spherical roller bearings.

36. A roller bearing cage according to claim 35, wherein:
the bridge elements are attached to an outer surface of the at least one circumferential element in the radial direction, and
at least one surface of the bridge elements configured to contact the roller bodies includes ship-hull-shaped lubricant pockets.

37. A roller bearing cage, comprising:
first and second annular elements, each having at least three radially-extending bulges at least substantially equal-distantly spaced around a circumferential direction of the annular elements, an axially-inward-facing surface of each bulge being configured to serve as a guide surface for one axial end of a roller body, and
a plurality of bridge elements bonded to and connecting the first and second annular elements, each bridge element being disposed between two adjacent bulges on a radial side of the annular elements that is opposite of a direction of extension of the radially-extending bulges, the bridge elements being configured to support axially-extending rolling surfaces of respective roller bodies such that a pocket for a roller body is defined between each two adjacent bridge elements and each two axially-opposing, radially-extending bulges.

38. A roller bearing cage according to claim 37, wherein:
the bulges extend radially inward and
the bridge elements are welded to a radially outer surface of the annular elements.

39. A roller bearing cage according to claim 38, wherein:
the annular elements each have a number of bulges equal to the number of bridge elements and to the number of roller bodies,
the annular elements each have a uniformly undulating shape in the circumferential direction,
at least an axially-extending portion of the bridge elements has a substantially trapezoid-shaped cross-section with at least one side curved to conform to the axially-extending rolling surface of the respective roller bodies,
the roller bearing cage is configured to support one of cylindrical roller bearings, tapered roller bearings and spherical roller bearings, and
surfaces of the bridge elements configured to contact the roller bodies include one of ship-hull-shaped lubricant pockets and droplet-shaped lubricant pockets.
